(19) United States
(12) Patent Application Publication
(10) Pub. No.: US 2009/0184092 A1
(43) Pub. Date: Jul. 23, 2009

(54) Palladium-Selective Etching Solution and Method for Controlling Etching Selectivity

(75) Inventor: Hideki Takahashi, Saitama (JP)

Correspondence Address: WOLF GREENFIELD & SACKS, P.C., 600 ATLANTIC AVENUE, BOSTON, MA, 02210-2206, US

(73) Assignee: Kanto Kagaku Kabuashiki Kaisha, Tokyo (JP)

(21) Appl. No.: 12/084,230

(22) PCT Filed: Oct. 27, 2006
(86) PCT No.: PCT/JP2006/321512

§ 371 Date: Mar. 9, 2009

(30) Foreign Application Priority Data
Oct. 28, 2005 (JP) 2005-314160

(51) Int. Cl. C09K 13/04; C09K 13/00; C23F 1/02

(52) U.S. Cl. 216/100; 252/79.1; 252/79.2

(57) ABSTRACT

Disclosed is an iodine-based etching solution for etching a material wherein palladium and gold coexist. This etching solution contains at least one additive selected from the group consisting of nitrogen-containing five-membered ring compounds, alcohol compounds, amide compounds, ketone compounds, thiocyanic acid compounds, amine compounds and imide compounds. The etching rate ratio between palladium and gold (etching rate of palladium/etching rate of gold) is not less than 1.

### TECHNICAL FIELD

The present invention relates to the technology for etching a material in which palladium and gold coexist.

### BACKGROUND OF THE INVENTION

In general, metals such as palladium and gold are widely used as materials for such applications as electrode wiring in semiconductors and liquid crystal display devices. Wet etching using chemicals is known as a technology for micromachining these metal electrode wirings. In particular in recent years, flip chip technology has become mainstream in the bonding of metal electrode wiring, and etching solutions are frequently used in bump formation processes.

In the prior art, examples of such etching solutions are iodine-based etching solutions containing organic solvents known, for example, from JP, A, 2004-211142. Even though these etching solutions permit the stable etching of gold with minimal variation of the etching properties, they do not allow the control of the etching amount of the respective metals when the gold bumps are etched together with the palladium substrate in the gold bump formation processes.

Moreover, a method for etching gold, palladium and alloys thereof with an etching solution in which iodine is the principal reactant is known from JP, A, 49-123132. Nevertheless, with this etching solution gold and palladium are etched in the same way; in other words, it is not possible to inhibit the etching of gold and to selectively remove the palladium of the substrate.

Meanwhile, the spread of micromachining technology in recent years has generated a strong demand for metal selective etching solutions, in other words, etching solutions capable of etching only the target metal while preventing damage to other metals.

### DISCLOSURE OF THE INVENTION

### Problems to be Solved by the Invention

The object of the present invention is to provide an etching solution with high palladium selectivity for etching a material in which palladium and gold coexist and a method for controlling the etching selectivity of palladium.

### Means for Solving the Problem

The present inventor, in the course of diligent studies to solve the above-mentioned problems, discovered that it is possible to change the etching rate ratio by adding a specific additive and completed the invention as a result of further studies.

In other words, the present invention relates to an iodine-based etching solution for etching a material in which palladium and gold coexist, comprising at least one additive selected from the group consisting of nitrogen-containing five-membered ring compounds, alcohol compounds, amide compounds, ketone compounds, thiocyanic acid compounds, amine compounds and imide compounds, and the etching rate ratio between palladium and gold (etching rate of palladium/etching rate of gold) is 1 or more.

The present invention further relates to the above-mentioned etching solution, wherein are contained, as additive, nitrogen-containing five-membered ring compounds or thiocyanic acid compounds.

The present invention also relates to the above-mentioned etching solution, wherein the nitrogen-containing five-membered ring compound is N-methyl-2-pyrrolidinone.

The present invention further relates to the above-mentioned etching solution, wherein the N-methyl-2-pyrrolidinone is 50 to 80 volume % of the etching solution.

The present invention also relates to the above-mentioned etching solution, wherein the thiocyanic acid compound is ammonium thiocyanate or potassium thiocyanate.

The present invention further relates to the above-mentioned etching solution, wherein are contained 0.15 to 1.0 mol/L of ammonium thiocyanate or 0.3 to 1.0 mol/L of potassium thiocyanate.

The present invention also relates to a method for controlling the etching selectivity of palladium, when a material in which palladium and gold coexist is etched with an iodine-based etching solution, wherein the iodine-based etching solution comprises at least one additive selected from the group consisting of nitrogen-containing five-membered ring compounds, alcohol compounds, amide compounds, ketone compounds, thiocyanic acid compounds, amine compounds and imide compounds and the etching selectivity of palladium is controlled by adjusting the concentration of the additive(s).

The present invention is based on the discovery that, by adding at least one additive selected from the group consisting of nitrogen-containing five-membered ring compounds, alcohol compounds, amide compounds, ketone compounds, thiocyanic acid compounds, amine compounds and imide compounds to an iodine-based etching solution, the etching rate of palladium is increased while the etching rate of gold decreases or remains almost unchanged, and that as a result thereof the ratio of the etching rate of palladium to the etching rate of gold increases. This effect is due to the fact that the above-mentioned additives have the tendency to coordinate with palladium rather than with gold. It is thought that the reason for this is that, in the case of palladium, the etching rate increases because of the acceleration of such effects as the removal of palladium iodide of the palladium surface due to the soluble palladium coordination compounds that are formed because of the additives; while in the case of gold, an increase or change of the etching ratio as in the case of palladium is not observed because coordination compounds are not easily formed with the above-mentioned additives.

Moreover, for the dissolution reaction to proceed, the supply from the solution of iodide ion that participates in the dissolution towards the material surface and the transfer of the iodide produced by the dissolution into the solution must proceed swiftly; the dissipation resulting from the difference in the concentration of reaction species between the reaction sites of the material surface and the solution is the driving force for the reaction. It is thought that, in the etching of both palladium and gold, compared to the case in which water is the sole solvent, the dissociation of the reaction species towards ion is suppressed in a water-organic solvent mixture; the entire activity is reduced and the difference in the concentrations between the material surface and the solution is reduced; in other words, there is a reduction in the dissipation speed. It is further thought that with palladium, in which the additives function as a ligand, the etching rate increases because of the dissolution acceleration effect that is due to the ligand (additive); compared to this, in the case of gold in which the additives do not function as a ligand, the etching rate decreases or remains almost unchanged because a dissolution acceleration effect due to the ligand (additive) is not obtained.

Consequently, according to the present invention the etching rate ratio between palladium and gold (etching rate of palladium/etching rate of gold) can be controlled so as to be 1 or more.

### Effect of the Invention

In the etching solution of the present invention, the ratio of the etching rate of palladium to the etching rate of gold is 1 or more; therefore, the selective etching of palladium, difficult in the prior art, has become possible, which makes it possible to respond to the demands of micromachining. In an etching solution in which the ratio of the etching rate of palladium to the etching rate of gold is 1 or more, the power with which palladium is etched is equal or higher than that with which gold is etched; therefore it is possible to etch palladium while preventing damage to gold to the utmost.

Moreover, according to the method of the present invention, it is possible to control the etching rate of palladium and the etching rate of gold at will by appropriately selecting the amount of at least one additive that is selected from the group consisting of nitrogen-containing five-membered ring compounds, alcohol compounds, amide compounds, ketone compounds, thiocyanic acid compounds, amine compounds and imide compounds; therefore, it is possible to change the etching selectivity of palladium at will in accordance with the aim of the production.

### BEST MODE FOR CARRYING OUT THE INVENTION

The etching solution of the present invention is an iodine-based etching solution, in other words, an etching solution comprising iodides such as iodine, potassium iodide, wherein is contained at least one additive selected from the group consisting of nitrogen-containing five-membered ring compounds, alcohol compounds, amide compounds, ketone compounds, thiocyanic acid compounds, amine compounds and imide compounds. In case the etching solution contains 2 or more additives, 2 or more additives may be selected from the same type of compounds or from different types of compounds.

The etching rate ratio between palladium and gold is the ratio of the etching rate of palladium to the etching rate of gold (hereinafter, abbreviated as Pd/Au ratio). In the etching solution of the present invention, the Pd/Au ratio is 1 or more. A Pd/Au ratio of 1 or more is obtained by increasing the etching power with which palladium is etched and suppressing the etching power with which gold is etched; in a material in which palladium and gold coexist, palladium, compared to gold, can be etched with a high selectivity. In the etching solution of the present invention, the Pd/Au ratio is preferably 1.5 or more. A high Pd/Au ratio is preferred and the upper limit is not particularly determined; however, it can for example be 50, it can also be 12.

The additives used in the present invention can be organic or inorganic compounds. Examples of organic compounds used as additive include nitrogen-containing five-membered ring compounds such as pyrrolidinone, imidazolidinone, oxazole, thiazole, oxadiazole, thiadiazole, tetrazole, triazole or the derivatives thereof. Specific examples of preferred nitrogen-containing five-membered ring compounds include N-methyl-2-pyrrolidinone (NMP), 2-pyrrolidinone, polyvinyl pyrrolidinone, 1-ethyl-2-pyrrolidinone, 1,3-dimethyl-2-imidazolidinone, 2-imidazolidinone, 2-imino-1-methyl-4-imidazolidinone, 1-methyl-2-imidazolidinone, 2,5-bis(1-phenyl)-1,1,3,4-oxazole, 2,5-bis(1-phenyl)-1,3,4-thiazole, 2,5-bis(1-phenyl)-4,3,4-oxadiazole, 2,5-bis(1-naphthyl)-1,3,4-oxadiazole, 1,4-bis[2-(5-phenyloxadiazolyl)]benzene, 1,4-bis[2-(5-phenyloxadiazolyl)-4-tert-butylbenzene], 2,5-bis(1-naphthyl)-1,3,4-thiadiazole, 2,5-bis(1-naphthyl)-1,3,4-thiadiazole, 1,4-bis[2-(5-phenylthiadiazolyl)]benzene, 2,5-bis(1-naphthyl)-4,3,4-triazole, 1,4-bis[2-(5-phenyltriazolyl)]benzene. Among these, NMP, 2-pyrrolidinone or 1,3-dimethyl-2-imidazolidinone are even more preferred, and NMP is still more preferred.

Examples of alcohol compounds include alcohols with a carbon number of 1 to 10; among these straight-chain, branched-chain or ring-shaped compounds which may be saturated or unsaturated can be used; polyols having 2 or more hydroxyl groups can also be used. Specific examples of preferred alcohol compounds include straight-chain alcohols such as methanol, ethanol, 1-propanol and hexanol and ring-shaped alcohols such as 1-cyclopentanol and 1-cyclohexanol. Among these, alcohols such as ethanol and 1-propanol are even more preferred.

The amide compounds are any compounds which have an amide group, they may also have a substituted group such as a nitro group, a phenyl group or a halogen group. Specific examples of preferred amide compounds include N-methylformamide, N,N-dimethylformamide, N,N-diethylformamide, N-methylacetamide, N,N-dimethylacetamide, N-methylpropionamide, acrylamide, adipamide, acetamide, 2-acetamide acrylic acid, 4-acetamide benzoic acid, 2-acetamide benzoic acid methyl, acetamide ethyl acetate, 4-acetamide phenol, 2-acetamide fluorene, 6-acetamide hexanoic acid, p-acetamide benzaldehyde, 3-acetamide malonic acid diethyl, 4-acetamide butyric acid, amide sulfuric acid, amide sulfuric acid ammonium, amidole, 3-aminobenzamide, p-aminobenzenesulfonamide, anthranilamide, isonicotinamide, N-isopropylacrylamide, N-isopropyl-1-piperazineacetamide, urea amidolyase, 2-ethoxybenzamide, erucylamide, oleic acid amide, 2-chloroacetamide, glycineamide hydrochloride, succinic acid amide, succinic acid diamide, salicylamide, 2-cyanoacetamide, 2-cyanothioacetamide, diacetamide, diacetoneacrylamide, diisopropylformamide, N,N-diisopropylisobutylamide, N,N-diethylacetoacetamide, N,N-diethylacetamide, N,N-diethyl dodecanoic acid amide, N,N-diethylnicotinamide, dicyanodiamide, N,N-dibutylformamide, N,N-dipropylacetamide, N,N-dimethylpropionamide, N,N-dimethylbenzamide, stearic acid amide, sulfanilamide, sulfabenzamide, sulfamide acid, dansylamide, thioacetamide, thioisonicotinamide, thiobenzamide, 3-nitrobenzamide, 2-nitrobenzamide, 2-nitrobenzensulfonamide, 3-nitrobenzensulfonamide, 4-nitrobenzensulfonamide, pyrrolinamide, pyrazinamide, 2-phenylbutylamide, N-phenylbenzamide, phenoxyacetamide, phthalamide, phthaldiamide, fumaramide, N-butylacetamide, n-butylamide, propanamide, propionamide, hexanoic acid amide, benzamide, benzensulfonamide, formamide, malonamide, malondiamide, methansulfonamide, N-methylbenzamide, N-methylmaleinamic acid and iodacetamide. Among these, compounds such as N-methylformamide and N,N-dimethylacetamide are even more preferred.

Examples of ketone compounds are ketone compounds with a carbon number of 3 to 10; specific examples of preferred ketone compounds include acetone, methylethylketone, cyclohexanone, dioxane, 4-hydroxy-2-methylpentanone, ethylene carbonate and propylene carbonate. Among these, acetone and ethylene carbonate are even more preferred.

Specific examples of preferred amine compounds include urea, glycine, iminodiacetic acid, N-acetylethanolamine, N-acetyldiphenylamine, allylamine, allylamine hydrochloride, allylcyclohexylamine, isoallylamine, isobutylamine, isopropanolamine, isopropylamine, ethanolamine, ethanolamine hydrochloride, ethylamine hydrochloride, N-ethylethanolamine, N-ethylethylenediamine, N-ethyldiisopropylamine, N-ethyldiethanolamine, N-ethyldicyclohexylamine, N-ethyl-n-butylamine, 2-ethylhexylamine, N-ethylbenzylamine, N-ethylmethylamine, ethylenediamine sulfate, ethylenediamine tetraacetic acid, tripotassium ethylenediamine tetraacetate trihydrate, trisodium ethylenediamine tetraacetate dihydrate, ethylenediamine, ethoxyamine hydrochloride, diallylamine, diisobutylamine, diisopropanolamine, diisopropylamine, diethanolamine, diethanolamine hydrochloride, diethylamine, diethylamine hydrochloride, diethylenetriamine, dicyclohexylamine, diphenylamine, diphenylamine hydrochloride, dimethylamine hydrochloride, N,N-dimethylallylamine, succinamine acid, stearylamine, stearylamine hydrochloride, sulfamine acid, thiamine hydrochloride, thiamine sulfate, triisopropanolamine, triisopentylamine, triethylenediamine, triphanylamine, tribenzylamine, trimethylenediamine, monoethanolamine and monoethanolamine hydrochloride.

Specific examples of preferred imide compounds include chain-shaped or ring-shaped imide compounds such as succinic acid imide, hydroxy succinimide, N-iodosuccinimide, N-acryloxysuccinimide, N-acetylphthalimide, 3-aminophthalimide, 4-aminophthalimide, N-aminophthalimide, imidurea, N-ethylphthalimide, N-ethylmaleimide, N-carbetoxyphthalimide, carbodiimide, N-chloro-succinic acid imide, cycloxyimide, 2,6-dichloroquinonechloroimide, 3,3-dimethylglutarimide, 1,8-naphthalimide, 3-nitrophthalimide, 4-nitrophthalimide, N-hydroxyphthalimide, potassium phthalimide, maleic acid imide, N-methyl-succinic acid imide and iodosuccinimide.

Among these additives, alcohol compounds and ketone compounds are preferred for the purpose of increasing the Pd/Au ratio; particularly preferred are such compounds as 1-propanol and acetone. Moreover, additives with a low volatility are preferred because they can maintain the etching of palladium at a stable rate. Examples of such additives include nitrogen-containing five-membered ring compounds. In particular, NMP, which has good wettability after etching, is preferred.

The amount of organic additives used is different for each type of additive; therefore it is preferred to appropriately adjust the amount in accordance with the additive(s) used. In general, the amount used can be in the range from 1 to 100 vol %, preferred is 10 to 85 vol %, even more preferred is 20 to 80 vol %. For example, in case of an NMP additive, the preferred amount is 50 to 80 vol %, even more preferred is 60 to 80 vol %.

Among additives of inorganic compounds, preferred examples of thiocyanic acid compounds include ammonium salts of thiocyanic acid, salts of alkali earth metals such as magnesium or calcium and salts of alkali metals such as sodium or potassium. Among these salts, ammonium thiocyanic acids or potassium thiocyanic acids, which have a high Pd/Au ratio, are preferred. Additives of inorganic compounds have the advantage that it is possible to increase the Pd/Au ratio even with small amounts.

It is preferred to appropriately adjust the amount of inorganic additives according to the type of additives used; however, preferred is 0.01 to 2 mol/L, even more preferred is 0.1 to 1.5 mol/L, still more preferred is 0.2 to 1 mol/L. In case of an ammonium thiocyanic acid additive, the amount of additive used is preferably 0.15 to 1.0 mol/L, even more preferred is 0.4 to 1.0 mol/L, still more preferred is 0.4 to 0.8 mol/L. In case of a potassium thiocyanic acid additive, the amount of additive used is preferably 0.3 to 1.0 mol/L, even more preferred is 0.4 to 1.0 mol/L, still more preferred is 0.6 to 0.8 mol/L. As long as the amount of additive is within these ranges, it is possible to increase the power with which palladium is etched and to suppress the power with which gold is etched.

The method of the present invention makes it possible to control the etching rate ratio between palladium and gold at will by adjusting the amount of additive(s) used. For example, when NMP was used as additive as shown in FIG. 1, the gold etching rate was higher than the palladium etching rate at 0 vol % of NMP. In contrast, at about 50 vol % or more of NMP a reversal phenomenon occurs when the palladium etching rate exceeds the gold etching rate. In other words, at 50 vol % or more of NMP the Pd/Au ratio is 1 or more (for example, at 60 vol % of NMP the Pd/Au ratio is about 1.64). Thus, the Pd/Au ratio can be controlled at will by adjusting the amount of NMP.

Similarly, the amount of additive at which the reversal of the etching rates of gold and palladium occurs is, respectively, at about 60 vol % or more when 2-pyrrolidinone is used as shown in FIG. 2, at about 80 vol % or more when 1,3-dimethyl-2-imidazolidinone (DMI) is used as shown in FIG. 3, at about 50 vol % or more when ethylene carbonate (EC) is used as shown in FIG. 4, at about 60 vol % or more when ethanol is used as shown in FIG. 5, at about 60 vol % or more when 1-propanol (NPA) is used as shown in FIG. 6, at about 40 vol % or more when acetone is used as shown in FIG. 7, at about 40 vol % or more when N-methylformamide is used as shown in FIG. 8, at about 60 vol % or more when N,N-dimethylacetamide is used as shown in FIG. 9, at about 0.15 mol/L or more when ammonium thiocyanate is used as shown in FIG. 10, and at about 0.3 mol/L or more when potassium thiocyanate is used.

Thus, by appropriately determining the amount of additive used, the Pd/Au ratio can be controlled at will and can be set as desired at 1 or more. Consequently, for example in the gold bump formation processes, it is possible to remove the palladium film of the substrate while preventing damage to the gold bumps to the utmost.

The etching solution of the present invention can be prepared by adding the above-mentioned additives to a known iodine-based etching solution or by mixing iodines, iodides and said additives with water. Moreover, the etching solution of the present invention can for example be prepared when etching is to be performed by adding the additive(s) to an iodine-based etching solution; there is no need to prepare it beforehand.

According to the present invention, any known etching method can be employed without any particular limitation as long as the etching solution of the present invention is used. Methods by which the object to be etched is brought into contact with the etching solution can for example include the dip method in which the object to be etched is immersed in a vessel filled with the etching solution. With this method it is preferred to perform uniform etching by forced circulation of the etching solution inside the etching tank while agitating the object to be etched. Other etching methods include the spray method, in which the etching solution is sprayed onto the surface of the object to be etched, and the spin method, in which the etching solution is ejected through a nozzle onto the object to be etched which is rotated. Moreover, it is also preferred to use these treatment methods together with the dip method. The etching time is not particularly limited, but etching of about 1 to 60 minutes is sufficient; the etching temperature is also not particularly limited, but etching can for example be performed in the range from 20 to 50 degrees Celsius.

Any material in which palladium and gold coexist can be etched with the etching solution of the present invention without any particular limitations. Specific examples include semiconductor materials such as semiconductor substrates, silicon wafers and transparent conductive electrodes. Among these, semiconductor substrates are preferred.

### EXAMPLES

Hereinafter, the present invention will be explained in more detail by way of the Examples without, however, limiting the present invention to these Examples.

### Comparative Example 1

The experiment was conducted by simulating the etching of palladium on a wafer in which palladium and gold coexist.

200 mL of an etching solution containing 110 g/L of potassium iodide and 22 g/L of iodine were prepared. Next, 2×2 cm specimens respectively of palladium and gold were etched by immersion in the above-mentioned etching solution for 1 minute while being gently stirred at a temperature of 30 degrees Celsius. The palladium and gold etching rates were determined by gravimetric method and the Pd/Au ratio was calculated. The results are shown in Tables 1 through 3. As can be seen from Tables 1 through 3, both the palladium etching rates and the Pd/Au ratios were low when no additive was used.

### Example 1

The experiment was conducted by simulating the etching of palladium on a wafer in which palladium and gold coexist. 4 etching solutions of 200 mL each were prepared by blending 20, 40, 60 and 80 vol %, respectively, of N-methyl-2-pyrrolidinone (NMP) with the etching solution of the above-mentioned Comparative Example. Next, 2×2 cm specimens respectively of palladium and gold were etched by immersion in the above-mentioned etching solution for 1 minute while being gently stirred at a temperature of 30 degrees Celsius. The palladium and gold etching rates were determined by gravimetric method and the Pd/Au ratio was calculated. The results are shown in Table 1 and FIG. 1.

It was found that, as a result of adding NMP, the palladium etching rate increased relative to the gold etching rate and that the Pd/Au ratio also increased. It was further found that the Pd/Au ratio changed according to the concentration of the additive and that it exceeds 1 when the palladium and gold etching rates are reversed by appropriately selecting the additive concentration.

### [Table 1]

TABLE 1

| Additive | Pd etching | Au etching | Etching rate |
|---|---|---|---|
| amount | rate | rate | ratio |
| (vol. %) | (nm/min) | (nm/min) | (Pd/Au) |
| 0 | 8 | 482 | 0.02 |
| 20 | 183 | 386 | 0.47 |
| 40 | 195 | 307 | 0.64 |
| 60 | 148 | 90 | 1.64 |
| 80 | 48 | 25 | 1.92 |

### Example 2

Etching was performed as in Example 1, except that the compounds shown in Table 2 were used instead of the NMP used in Example 1. The results are shown in Table 2. Moreover, for cases in which ethylene carbonate, ethanol, acetone and N,N-dimethylacetamide are used as additive, the relationship between the additive amount and the etching rate is shown in FIGS. 4, 5, 7 and 9, respectively. It was found that, as a result of adding an additive, the palladium etching rate increased relative to the gold etching rate and that the Pd/Au ratio also increased. It was further found that the Pd/Au ratio exceeds 1 when the palladium and gold etching rates are reversed by appropriately selecting the additive concentration.

### [Table 2]

TABLE 2

| | | Pd | Au | Etching |
|---|---|---|---|---|
| | Additive | etching | etching | rate |
| | amount | rate | rate | ratio |
| Compound | (vol %) | (nm/min.) | (nm/min.) | (Pd/Au) |
| none | — | 8 | 482 | 0.02 |
| 2-pyrrolidinone | 20 | 210 | 418 | 0.50 |
| | 40 | 235 | 326 | 0.72 |
| | 60 | 162 | 150 | 1.08 |
| | 80 | 57 | 33 | 1.73 |
| 1,3-dimethyl-2- | 20 | 85 | 325 | 0.26 |
| imidazolidinone | 40 | 75 | 305 | 0.25 |
| | 60 | 109 | 140 | 0.78 |
| | 80 | 31 | 31 | 1.00 |
| Ethylene | 20 | 451 | 530 | 0.85 |
| carbonate | 40 | 470 | 493 | 0.95 |
| | 60 | 473 | 418 | 1.13 |
| | 80 | 482 | 334 | 1.44 |
| Ethanol | 20 | 64 | 367 | 0.17 |
| | 40 | 94 | 247 | 0.38 |
| | 60 | 173 | 206 | 0.84 |
| | 80 | 441 | 213 | 2.07 |
| 1-propanol | 20 | 17 | 156 | 0.11 |
| | 40 | 18 | 80 | 0.23 |
| | 60 | 60 | 94 | 0.64 |
| | 80 | 326 | 128 | 2.55 |
| Acetone | 20 | 156 | 364 | 0.43 |
| | 40 | 157 | 160 | 0.98 |
| | 60 | 185 | 50 | 3.70 |
| | 80 | 316 | 28 | 11.29 |
| N-methylformamide | 20 | 211 | 436 | 0.48 |
| | 40 | 375 | 344 | 1.09 |
| | 60 | 427 | 364 | 1.17 |
| | 80 | 425 | 268 | 1.59 |
| N,N-dimethylacetamide | 20 | 131 | 349 | 0.38 |
| | 40 | 164 | 346 | 0.47 |
| | 60 | 195 | 168 | 1.16 |
| | 80 | 88 | 41 | 2.15 |

### Example 3

Etching was performed as in Example 1, except that the compounds shown in Table 3 were used instead of the NMP used in Example 1. The results are shown in Table 3. Moreover, the relationship between the amount of thiocyanic acid ammonium and the etching rate is shown in FIG. 6. It was found that, as a result of adding an additive, the palladium etching rate increased and that the Pd/Au ratio also increased. It was further found that the Pd/Au ratio exceeds 1 when the palladium and gold etching rates are reversed by appropriately selecting the additive concentration.

### [Table 3]

TABLE 3

| | | Pd | Au | Etching |
|---|---|---|---|---|
| | Additive | etching | etching | rate |
| | amount | rate | rate | ratio |
| Compound | (mol/l) | (nm/min.) | (nm/min.) | (Pd/Au) |
| none | — | 8 | 482 | 0.02 |
| ammonium | 0.2 | 975 | 653 | 1.49 |
| thiocyanate | 0.4 | 1403 | 707 | 1.98 |
| | 0.6 | 1564 | 790 | 1.98 |
| | 0.8 | 1415 | 728 | 1.94 |
| | 1.0 | 1395 | 769 | 1.81 |
| potassium | 0.2 | 395 | 623 | 0.63 |
| thiocyanate | 0.4 | 979 | 676 | 1.45 |
| | 0.6 | 1381 | 693 | 1.99 |
| | 0.8 | 1386 | 711 | 1.95 |
| | 1.0 | 1409 | 773 | 1.82 |

### BRIEF DESCRIPTION OF THE DRAWINGS

FIG. 1 shows the relationship between the amount of N-methyl-2-pyrrolidinone (NMP) and the etching rates when a material was etched in which palladium and gold coexist.

FIG. 2 shows the relationship between the amount of 2-pyrrolidinone and the etching rates when a material was etched in which palladium and gold coexist.

FIG. 3 shows the relationship between the amount of 1,3-dimethyl-2-imidazolidinone (DMI) and the etching rates when a material was etched in which palladium and gold coexist.

FIG. 4 shows the relationship between the amount of ethylene carbonate (EC) and the etching rates when a material was etched in which palladium and gold coexist.

FIG. 5 shows the relationship between the amount of ethanol and the etching rates when a material was etched in which palladium and gold coexist.

FIG. 6 shows the relationship between the amount of 1-propanol (NPA) and the etching rates when a material was etched in which palladium and gold coexist.

FIG. 7 shows the relationship between the amount of acetone and the etching rates when a material was etched in which palladium and gold coexist.

FIG. 8 shows the relationship between the amount of N-methylformamide and the etching rates when a material was etched in which palladium and gold coexist.

FIG. 9 shows the relationship between the amount of N,N-dimethylacetamide and the etching rates when a material was etched in which palladium and gold coexist.

FIG. 10 shows the relationship between the amount of thiocyanic acid ammonium and the etching rates when a material was etched in which palladium and gold coexist.

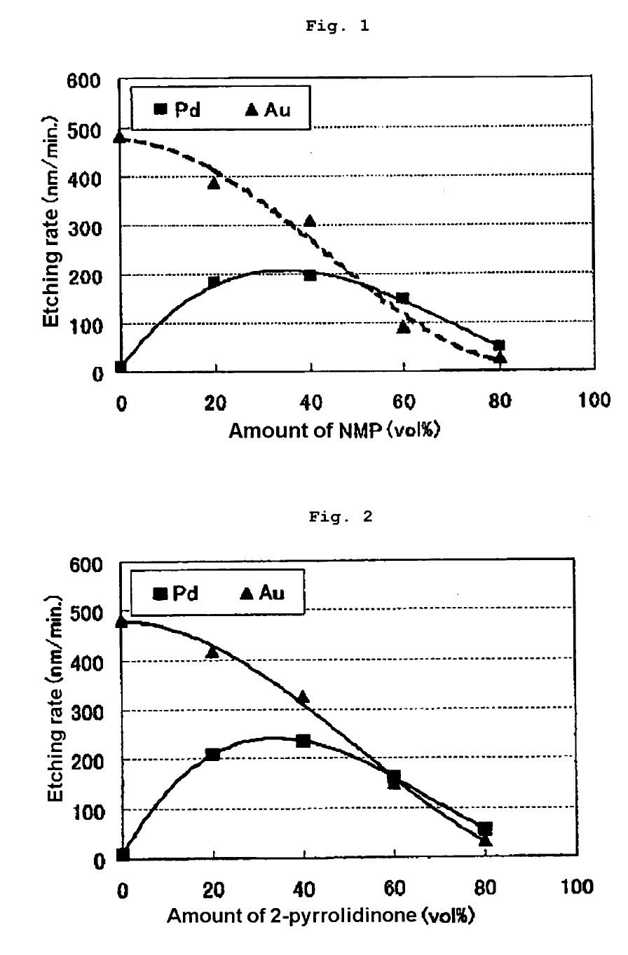

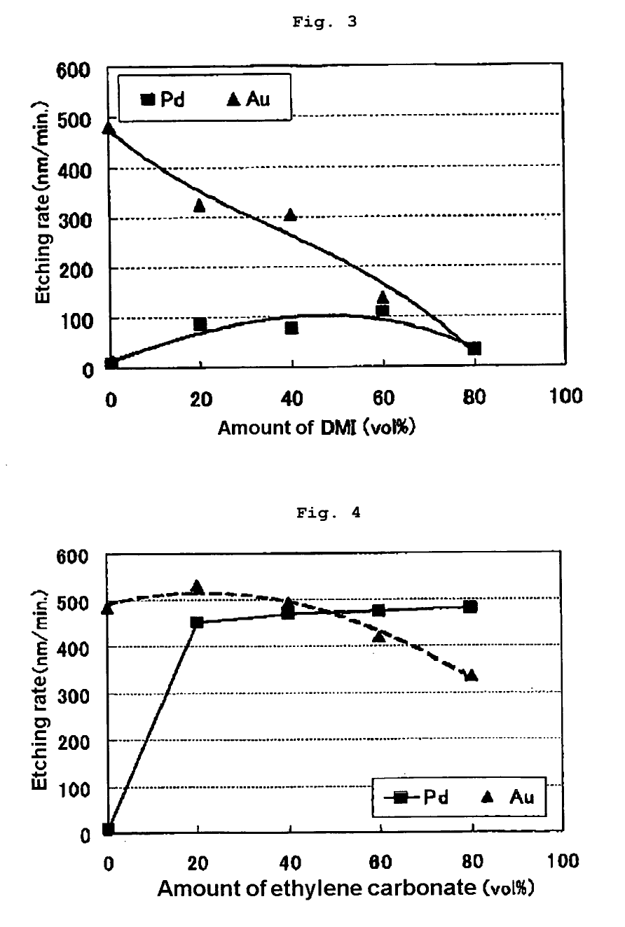

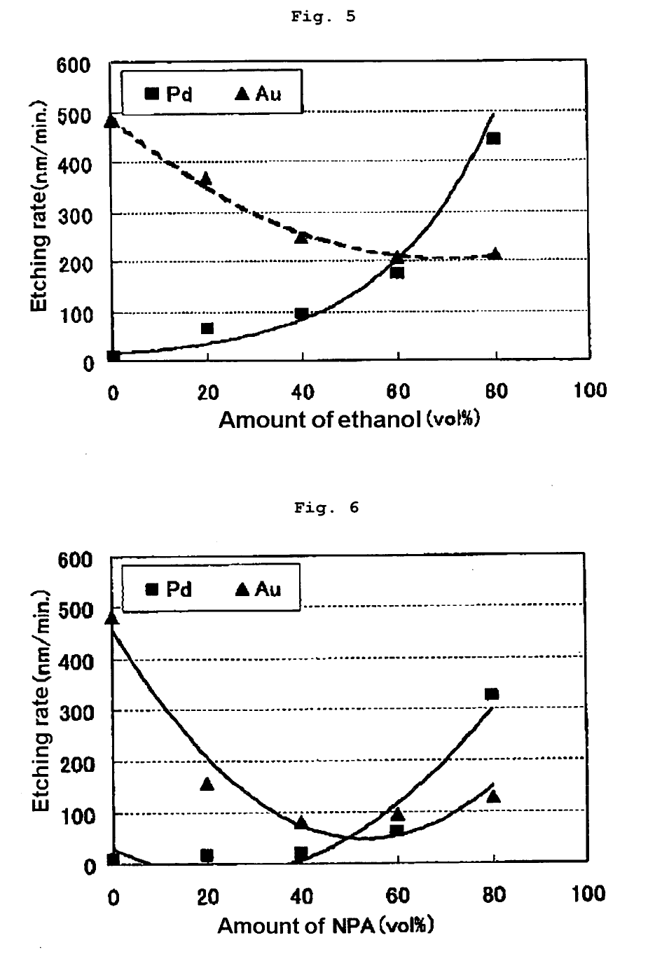

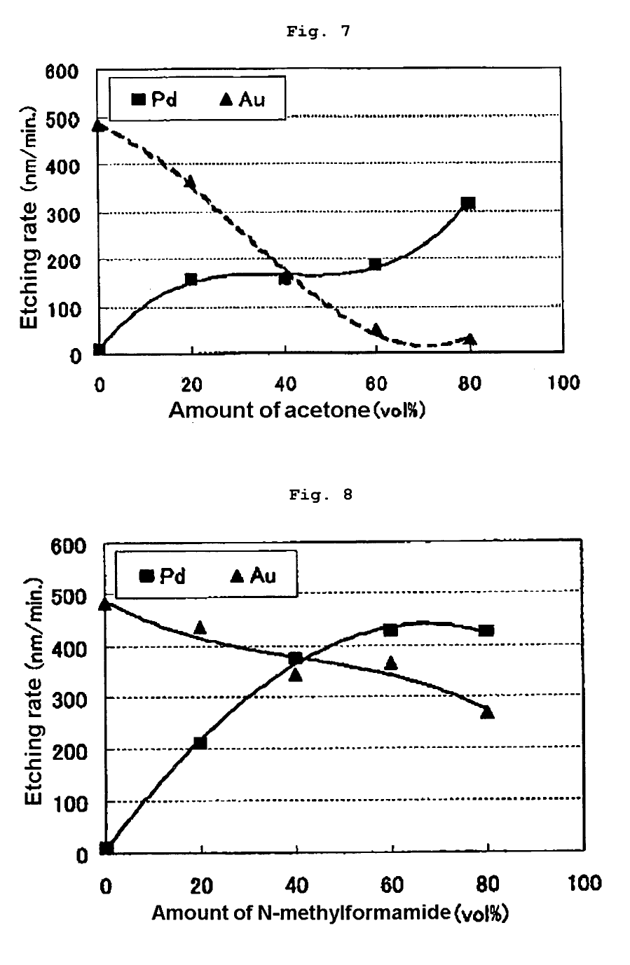

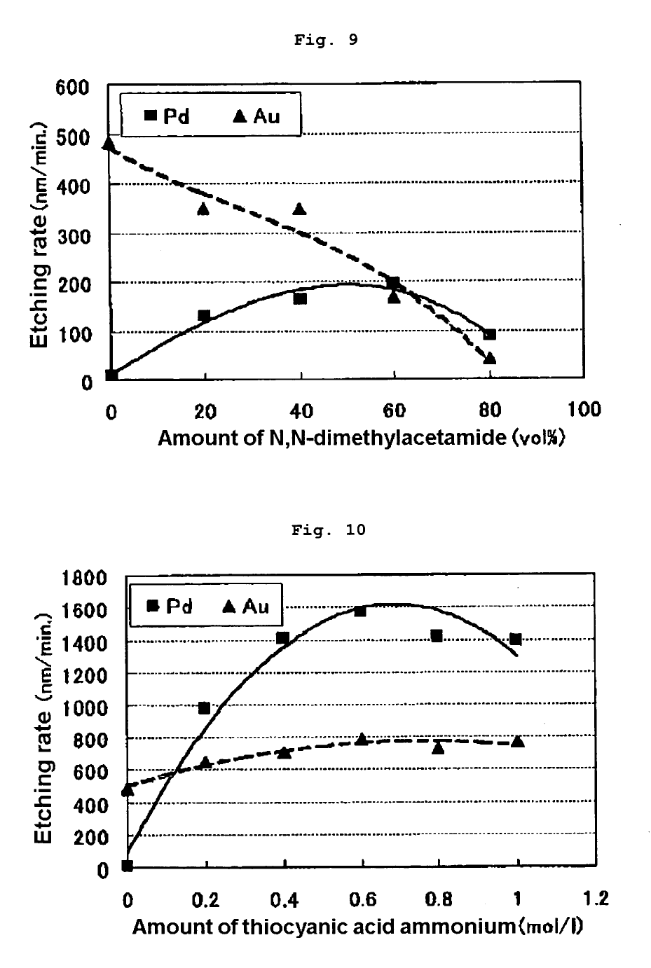

1. An iodine-based etching solution for etching a material in which palladium and gold coexist, comprising at least one additive selected from the group consisting of nitrogen-containing five-membered ring compounds, alcohol compounds, amide compounds, ketone compounds, thiocyanic acid compounds, amine compounds and imide compounds, and the etching rate ratio between palladium and gold (etching rate of palladium/etching rate of gold) is 1 or more.

2. The etching solution according to claim 1, wherein are contained, as additive, nitrogen-containing five-membered ring compounds or thiocyanic acid compounds.

3. The etching solution according to claim 1, wherein the nitrogen-containing five-membered ring compound is N-methyl-2-pyrrolidinone.

4. The etching solution according to claim 3, wherein the N-methyl-2-pyrrolidinone is 50 to 80 volume % of the etching solution.

5. The etching solution according to claim 2, wherein the thiocyanic acid compound is ammonium thiocyanate or potassium thiocyanate.

6. The etching solution according to claim 5, wherein are contained 0.15 to 1.0 mol/L of ammonium thiocyanate or 0.3 to 1.0 mol/L of potassium thiocyanate.

7. Method for controlling the etching selectivity of palladium, when a material in which palladium and gold coexist is etched with an iodine-based etching solution, wherein the iodine-based etching solution comprises at least one additive selected from the group consisting of nitrogen-containing five-membered ring compounds, alcohol compounds, amide compounds, ketone compounds, thiocyanic acid compounds, amine compounds and imide compounds, and the etching selectivity of palladium is controlled by adjusting the concentration of the additive(s).
